(19) United States
(12) Patent Application Publication
(10) Pub. No.: US 2026/0131994 A1
(43) Pub. Date: May 14, 2026

(54) STACKING APPARATUS FOR ALTERNATELY STACKING A CONTINUOUS RIBBON-LIKE SEPARATOR AND FOIL SHEETS AND METHOD FOR STACKING A CONTINUOUS RIBBON-LIKE SEPARATOR AND FOIL SHEETS

(71) Applicant: G.D S.p.A., Bologna (IT)

(72) Inventor: Giacomo Noferini, Bologna (IT)

(21) Appl. No.: 19/118,404

(22) PCT Filed: Oct. 3, 2023
(86) PCT No.: PCT/IB2023/059899

§ 371 Date: Apr. 4, 2025

(30) Foreign Application Priority Data
Oct. 7, 2022 (IT) 102022000020712

(51) Int. Cl. B65H 45/20; B65H 45/101; H01M 10/0585

(52) U.S. Cl. CPC B65H 45/20; B65H 45/101; H01M 10/0585; B65H 2801/72

(57) ABSTRACT

A stacking apparatus (1) comprising a stacking station (26) configured to receive foil sheets (100, 101); a first transfer device (10) for transferring first foil sheets (100) and a second transfer device (11) for transferring second foil sheets (101) movable alternately between a pick-up position and a release position; a feeder device (27) of a ribbon-like separator (102) towards the stacking station (26); a displacement device (29) fed by the feeder device (27) and comprising an accompanying device (30) movable between a first end position (P1) and a second end position (P2) and above the stacking station (26) when the second transfer device (11) moves from the release position to the pick-up position, and movable from the second end position (P2) to the first end position (P1) and above the stacking station (26) when the first transfer device (10) moves from the release position to the pick-up position. The displacement device (29) moves the accompanying device (30) between the first end position (P1) and the second end position (P2) and between the second end position (P2) and the first end position (P1) along a curved path (PC).

### CROSS-REFERENCE TO RELATED APPLICATION DATA

This application is a U.S. National Stage Application of International Application No. PCT/IB2023/059899, filed Oct. 3, 3023, which claims the benefit of and priority to Italian Patent Application No. 102022000020712, filed Oct. 7, 2022, the disclosure of each is hereby incorporated herein by reference in its entirety.

### FIELD

The present invention refers to a stacking apparatus for alternately stacking a continuous ribbon-like separator and foil sheets, and to a method for stacking a continuous ribbon-like separator and foil sheets, wherein foil sheets are stacked with each other with the interposition of a continuous ribbon-like separator.

The present invention is preferably directed to a stacking apparatus and to a method for alternately stacking a continuous ribbon-like separator and foil sheets wherein the continuous ribbon-like separator is a dielectric separator and the foil sheets are electrodes.

The present invention can be used to make electrochemical cells, for example secondary electrochemical cells, comprising flat electrodes separated from each other by a continuous dielectric separator.

### BACKGROUND

In the industrial sector of the production of electric accumulators, electrochemical cells are produced made from stacks of positive and negative electrodes, arranged alternately one above the other, with interposed a separation layer of dielectric material, generally indicated in the technical jargon of the sector with the term “separator”, formed by a single continuous ribbon folded between the electrodes.

In the experience of the Applicant, such electrochemical cells may be produced with a stacking apparatus for stacking one or more continuous ribbon-like separators and foil sheets to automate the production process.

In accordance with the experience of the Applicant, such a stacking apparatus may comprise a fixed base frame on which there are mounted a first foil sheet receiving station, a second foil sheet receiving station and a stacking station located between the two receiving stations. Above the fixed frame there is positioned a movable frame that moves with a straight reciprocating motion parallel to the fixed frame. Four foil sheet gripping equipment are mounted on the movable frame, which move with a straight reciprocating motion perpendicularly to the fixed frame. On the movable frame, fixed to the movable frame there is also mounted a separator guide which is fed by a continuous separator coil. The separator guide comprises two idle accompanying rollers, having rotation axes parallel to each other and placed on the same plane parallel to the fixed frame, which divert the path of the separator. In use, with the movable frame stationary, a first gripping equipment picks up, by translating perpendicularly to the stationary frame, a foil sheet from a first stack of foil sheets while a second gripping equipment picks up, by translating perpendicularly to the stationary frame, a foil sheet previously positioned on the first receiving station. Subsequently, by translating the movable frame, the second gripping equipment translates so as to position the foil sheet picked up in the stacking station and, at the same time, the first gripping equipment positions the sheet picked up from the stack on the first receiving station. In the moment in which the first gripping equipment and the second gripping equipment are picking up the respective foil sheets, the third gripping equipment and the fourth gripping equipment deposit, respectively, a foil sheet (picked up from a second stack of foil sheets) in the second receiving station and a foil sheet (picked up from the second receiving station) in the stacking station. In the moment in which the first gripping equipment and the second gripping equipment are depositing the respective foil sheets, the third gripping equipment and the fourth gripping equipment pick up, respectively, a foil sheet from the second stack of foil sheets and from the second receiving station. When the movable frame translates to move the second or fourth gripping equipment away from the stacking station (where they have deposited the respective foil sheet), the accompanying rollers translate integrally with the movable frame above the foil sheet just deposited in the stacking station and position the separator above the foil sheet just deposited. The accompanying rollers are rotated around their rotation axis by the separator itself. A retaining member retains the separator above the just deposited foil sheet. The process is actuated cyclically until a cell is formed which is composed of a stack of foil sheets in which each foil sheet is separated from another foil sheet by the continuous ribbon-like separator which then assumes an “accordion” shape within the cell. When the cell is completed, the separator is cut and the cell thus obtained is removed from the stacking station to free the stacking station and allow to repeat the entire process so as to make a further cell.

The need is increasingly felt, particularly in the industrial sector of the production of electric accumulators, to be able to have stacking apparatuses for alternately stacking a continuous ribbon-like separator and foil sheets that allow high production rates, that is, that allow high cell production speeds.

### SUMMARY

The Applicant has noted that by using an apparatus of the type summarily described above, the production speed could be limited by the time necessary to position the separator above the cell being formed in the stacking station.

The Applicant has in fact noted that it is necessary to make sure that the retaining member, or the retaining members, which retain the separator on the respective foil sheets are actually able to intercept the separator and to bring it into abutment against the upper surface of the foil sheet. Therefore, in the experience of the Applicant, it is necessary that this retaining member is raised until reaching and overcoming the level at which the separator transported by the accompanying rollers is placed, it intercepts the separator and lowers it to a lower level to bring it into close contact with the foil sheet.

The Applicant has noted that the stacking apparatus cannot perform any other operation or movement during the displacements of the retaining member, precisely to ensure that the separator is correctly positioned and retained on the foil sheet just deposited in the stacking station.

The Applicant has perceived that by increasing the movement speed of the retaining member it would be possible to decrease the time necessary for the correct positioning of the separator.

The Applicant has however noted that this could cause a damage or a tearing of the separator. The Applicant has in fact verified that an increase in the speed of descent (i.e. the speed in the direction directed towards the upper surface of the foil sheet) of the retaining member could result in a too abrupt impact of the retaining member against the separator with consequent damage to the same.

The Applicant has perceived that if the distance that the retaining member must travel to reach and overcome the level at which the separator is placed and to bring the separator against the upper surface of the foil sheet is decreased, the time necessary for the correct positioning of the separator would decrease also at the same movement speed of the retaining member.

The Applicant has found that by making an accompanying device of the continuous ribbon-like separator travel along a curved trajectory above the cell being formed, it would be possible to position the continuous ribbon-like separator in such a way that at the centre of the cell being formed the continuous ribbon-like separator is at a different level than the levels reached at the opposite ends of the cell being formed. In this way, by choosing this curved trajectory with concavity facing the cell being formed or with concavity facing away from the cell being formed (depending on the positioning of retaining devices with respect to the cell being formed), it would be possible to approach the continuous ribbon-like separator to the retaining devices ensuring that the continuous ribbon-like separator does not interfere with the cell being formed during its passage above the cell being formed.

The present invention therefore relates, in a first aspect thereof, to a stacking apparatus for alternately stacking a continuous ribbon-like separator and foil sheets.

Preferably, the apparatus comprises a stacking station configured to receive foil sheets.

Preferably, the apparatus comprises a first transfer device for transferring first foil sheets and a second transfer device for transferring second foil sheets respectively movable between a pick-up position and a release position.

Preferably, the release position of the first transfer device and the release position of the second transfer device are placed at said stacking station.

Preferably, when the first transfer device is in the release position the second transfer device is moved away from the release position and when the second transfer device is in the release position the first transfer device is moved away from the release position.

Preferably, the apparatus comprises a feeder device of a continuous ribbon-like separator configured to feed a continuous ribbon-like separator towards the stacking station.

Preferably, the apparatus comprises a displacement device configured to operate on the continuous ribbon-like separator fed by the feeder device.

Preferably, the displacement device comprises an accompanying device movable between a first end position and a second end position.

Preferably, the accompanying device moves between the first end position and the second end position above the stacking station when the second transfer device moves from the release position to the pick-up position.

Preferably, the accompanying device moves between the second end position and the first end position and above the stacking station when the first transfer device moves from the release position to the pick-up position.

Preferably, the displacement device moves the accompanying device between the first end position and the second end position and between the second end position and the first end position along a curved path.

The Applicant has verified that by moving the accompanying device between the first end position and the second end position and between the second end position and the first end position along a curved path, it is possible to intercept the continuous ribbon-like separator at the end positions where the continuous ribbon-like separator is closer to the retaining devices, thus making the retaining devices travel reduced distances and therefore taking reduced times for the correct positioning of the continuous ribbon-like separator above the just deposited foil sheet.

The present invention relates, in a second aspect thereof, to a method for alternately stacking a continuous ribbon-like separator and foil sheets.

Preferably, it is provided to transfer first foil sheets and second foil sheets to a stacking station.

Preferably, it is provided to feed a continuous ribbon-like separator to the stacking station.

Preferably, it is provided to lay the continuous ribbon-like separator on the first foil sheets and on the second foil sheets transferred to the stacking station.

Preferably, laying the continuous ribbon-like separator comprises moving the continuous ribbon-like separator above the stacking station along a first trajectory between a first end position and a second end position and along a second trajectory between a second end position and a first end position.

Preferably, the first trajectory and the second trajectory are curved trajectories.

“Foil sheet” means a plate having two dimensions much larger than a third dimension. The foil sheet may be a monolithic plate or a plate formed by a plurality of layers joined together made of identical material or different materials.

“Continuous ribbon-like separator” means a ribbon having a dimension much greater than two further dimensions, wherein a first dimension of such two further dimensions is much greater than a second dimension of such two further dimensions. The ribbon can be monolithic or formed by a plurality of layers joined together made of identical material or different materials.

“Curve” when referred to a path or to a trajectory, means the trajectory described on a plane by a point object that moves continuously between an initial point and an end point wherein this trajectory can be decomposed, on said plane, into at least two components that are not parallel to each other. Preferably, a “curve” does not comprise straight trajectory portions.

“Level” with respect to a surface, for example with respect to a stacking surface, means the distance (along a direction perpendicular to said surface) of an element from an absolute parallel reference plane passing through said surface. A “lower” level of an element with respect to said surface places said element below said absolute reference plane. An “upper” level of an element with respect to said surface places said element above said absolute reference plane.

By “at a station” when referred to the position of a receptacle, it is meant that said receptacle is exactly in that station, or is about to reach that station, or has just left that station.

The present invention may have, in one or both aspects thereof, at least one of the preferred features described below. Such features may be present individually or in combination with each other, unless expressly stated otherwise, both in the apparatus and in the method of the present invention.

Preferably, the accompanying device is configured to lay the continuous ribbon-like separator on the stacking station.

Preferably, the curved path followed by the accompanying device has a concavity facing the stacking station.

Preferably, said curved path is an arc of circumference.

Preferably, the first trajectory of the continuous ribbon-like separator coincides with the second trajectory of the continuous ribbon-like separator.

Preferably, the first path of the continuous ribbon-like separator and the second path of the continuous ribbon-like separator define a curved path.

Preferably, said curved path has concavity facing the stacking station.

Preferably, said curved path is an arc of circumference.

Preferably, said displacement device comprises an oscillating arm driven by an actuating shaft and supporting said accompanying device.

Preferably, said actuating shaft is placed, with respect to said stacking station, on the opposite side with respect to said feeder device of a continuous ribbon-like separator.

Preferably, said actuating shaft moves the oscillating arm with a reciprocating motion having a first point of reversal of motion at the first end position of the accompanying device and a second point of reversal of motion at the second end position of the accompanying device.

Preferably, said actuating shaft reverses the displacement direction of the oscillating arm at the first point of reversal of motion and at the second point of reversal of motion.

Preferably, the accompanying device is supported at a first end of said oscillating arm.

Preferably, the actuating shaft is connected to the oscillating arm in a distal position with respect to the accompanying device.

Preferably, the actuating shaft is connected to a second end, opposite to the first, of the oscillating arm.

Preferably, there is provided a receptacle configured to receive foil sheets placed in said stacking station.

Preferably, transferring first foil sheets and second foil sheets to the stacking station comprises depositing first foil sheets alternating and overlapping with second foil sheets on a stacking surface.

Preferably, the receptacle comprises a substantially flat stacking surface.

Preferably said stacking surface lies in a plane parallel to the actuating shaft.

Preferably, when said accompanying device is placed in an intermediate position between the first and second end position, the accompanying device is located, with respect to a direction perpendicular to the stacking surface, on the opposite side of the stacking surface with respect to when said accompanying device is placed in at least one between the first and second end positions.

Preferably, when said accompanying device is placed in an intermediate position between the first and second end positions, the accompanying device is located at a greater level with respect to the stacking surface.

Preferably, when said accompanying device is placed in the first end position, the accompanying device is at a lower level than the stacking surface.

Preferably, when said accompanying device is placed in the second end position, the accompanying device is located at a lower level than the stacking surface.

Preferably, said intermediate position between the first and the second end position is substantially equally spaced from the first end position and from the second end position.

Preferably, when said accompanying device is placed in the first end position, or when said accompanying device is placed in the second end position, said stacking surface is interposed, with respect to a direction perpendicular to the stacking surface, between the feeder device and said accompanying device.

Preferably, when said accompanying device is placed in the first end position and when said accompanying device is placed in the second end position, said stacking surface is interposed, with respect to a direction perpendicular to the stacking surface, between the feeder device and said accompanying device.

Preferably, moving the continuous ribbon-like separator above the stacking station comprises, during the displacement of the continuous ribbon-like separator from the first end position to an intermediate position between the first end position and the second end position, moving the continuous ribbon-like separator perpendicularly to, and away from, a second foil sheet transferred to the stacking station.

Preferably, moving the continuous ribbon-like separator above the stacking station comprises, during the displacement of the continuous ribbon-like separator from an intermediate position between the first end position and the second end position, moving the continuous ribbon-like separator perpendicularly to, and towards, a second foil sheet transferred to the stacking station.

Preferably, moving the continuous ribbon-like separator above the stacking station comprises moving the continuous ribbon-like separator to the first end position and below a level at which there is a first foil sheet transferred to the stacking station.

Preferably, moving the continuous ribbon-like separator above the stacking station comprises moving the continuous ribbon-like separator to the second end position and below a level at which there is a second foil sheet transferred to the stacking station.

The Applicant thinks that in this way the adhesion of the continuous ribbon-like separator to the foil sheet just deposited in the stacking station is facilitated.

Preferably, in the first end position the accompanying device is placed at a first distance from the stacking surface.

Preferably, in the second end position the accompanying device is placed at a second distance from the stacking surface.

Preferably, in an intermediate position between the first and the second end position the accompanying device is placed at a third distance from the stacking surface.

Preferably, said intermediate position is placed at an apex point of the curved path travelled by the accompanying device.

Preferably, said third distance is greater than the first distance and greater than the second distance.

Preferably, the first distance is substantially equal to the second distance.

The Applicant thinks that by providing the first distance and the second distance smaller than the third distance, the continuous ribbon-like separator can easily adhere to the cell being formed, and in particular to the foil sheet just deposited, without the need to have to subject the continuous ribbon-like separator to actions that may cause excessive stretching of the continuous ribbon-like separator.

Preferably, moving the continuous ribbon-like separator above the stacking station along a first trajectory between a first end position and a second end position and along a second trajectory between a second end position and a first end position comprises partially wrapping the first foil sheets and the second foil sheets transferred to the stacking station with the continuous ribbon-like separator.

Preferably, there is provided a first retaining device configured to operate on the continuous ribbon-like separator.

Preferably, the first retaining device is arranged at the first end position of the accompanying device.

Preferably, there is provided a second retaining device configured to operate on the continuous ribbon-like separator.

Preferably, the second retaining device is arranged at the second end position of the accompanying device.

Preferably, the first retaining device and the second retaining device are configured to retain the continuous ribbon-like separator on a stack of foil sheets being formed in the stacking station.

Preferably, the first retaining device and the second retaining device are placed on the opposite side of the receptacle placed in the stacking station along a direction contained in a plane perpendicular to the actuating shaft.

Preferably, the first retaining device is configured to retain a portion of continuous ribbon-like separator deposited on the last foil sheet deposited by the second transfer device in the stacking station.

Preferably, the first retaining device is configured to retain a portion of continuous ribbon-like separator while the continuous ribbon-like separator is deposited on the last foil sheet deposited by the first transfer device in the stacking station.

Preferably, the second retaining device is configured to retain a portion of continuous ribbon-like separator deposited on the last foil sheet deposited by the first transfer device in the stacking station.

Preferably, the second retaining device is configured to retain a portion of continuous ribbon-like separator while the continuous ribbon-like separator is deposited on the last foil sheet deposited by the second transfer device in the stacking station.

Preferably, said first retaining device is movable between a retaining condition, in which it intercepts and retains a portion of the continuous ribbon-like separator, and a release condition in which it is moved away from the continuous ribbon-like separator.

Preferably, said first retaining device moves from the retaining position to the release position and from the release position to the retaining position when the accompanying device is close to the first end position.

Preferably, said first retaining device moves from the retaining position to the release position and from the release position to the retaining position by performing a movement having a component perpendicular to the stacking surface of the receptacle.

Preferably, said component perpendicular to the stacking surface of the receptacle of the movement made by the first retaining device is greater than said first distance.

Preferably, said component perpendicular to the stacking surface of the receptacle of the movement made by the first retaining device is smaller than said third distance.

Preferably, the first retaining device is in the retaining position when the accompanying device moves between the first end position and the second end position.

Preferably, the first retaining device is in the retaining position when the accompanying device is in the second end position.

Preferably, the first retaining device is in the retaining position when the accompanying device moves between the second end position and the first end position.

Preferably, said second retaining device is movable between a retaining condition in which it intercepts and retains a portion of the continuous ribbon-like separator and a release condition in which it is moved away from the continuous ribbon-like separator.

Preferably, said second retaining device moves from the retaining position to the release position and from the release position to the retaining position when the accompanying device is close to the second end position.

Preferably, said second retaining device moves from the retaining position to the release position and from the release position to the retaining position by performing a movement having a component perpendicular to the stacking surface of the receptacle.

Preferably, said component perpendicular to the stacking surface of the receptacle of the movement performed by the second retaining device is greater than said second distance.

Preferably, said component perpendicular to the stacking surface of the receptacle of the movement performed by the second retaining device is smaller than said third distance.

Preferably, the second retaining device is in the retaining position when the accompanying device moves between the second end position and the first end position.

Preferably, the second retaining device is in the retaining position when the accompanying device is in the first end position.

Preferably, the second retaining device is in the retaining position when the accompanying device moves between the first end position and the second end position.

Preferably, during the deposition of foil sheets onto the receptacle placed in the stacking station, when the first retaining device is in the release position the second retaining device is in the retaining position and when the second retaining device is in the release position the first retaining device is in the retaining position.

Preferably, the stacking surface of the receptacle is movable between a plurality of stacking positions.

Preferably, in each stacking position the stacking surface is arranged parallel to a respective reference plane.

Preferably, all reference planes are parallel to each other.

Preferably, the reference planes follow one another along a direction perpendicular to the stacking surface.

Preferably, the reference planes follow one another between a reference plane more distant from the actuating shaft of the oscillating arm and a reference plane closer to the actuating shaft of the oscillating arm.

Preferably, a reference plane is spaced from an adjacent reference plane by a distance greater than or substantially equal to a thickness of a foil sheet.

Preferably, a reference plane is spaced from an adjacent reference plane by a distance substantially equal to the sum of a thickness of a foil sheet and of a thickness of the continuous ribbon-like separator.

Preferably, the stacking surface moves from a stacking position more distant from the actuating shaft of the oscillating arm to a stacking position closer to the actuating shaft of the oscillating arm when the first transfer device or the second transfer device deposit a respective foil sheet in the receptacle placed in the stacking station.

Preferably, the stacking surface is retained by the first retaining device or by the second retaining device in a stacking position reached.

Preferably, there is provided a plurality of receptacles.

Preferably, each receptacle is configured to receive foil sheets stacked together.

Preferably, each receptacle is movable between the stacking station and an unloading station.

Preferably, when a receptacle of said plurality of receptacles is in the stacking station another receptacle of said plurality of receptacles is at the unloading station.

The Applicant thinks that in this way it is possible to further increase the production speed of the apparatus object of the present invention.

The Applicant has in fact noted that the removal of the formed cell from the stacking station necessarily requires stopping the apparatus to allow a human operator, or a robotic system, to reach the formed cell and extract it.

The Applicant has verified that when a receptacle of the plurality of receptacles is in the stacking station and another receptacle of the plurality of receptacles (on which a stack of foil sheets separated from each other by the ribbon-like separator has already been deposited) is at the unloading station, the time required to deposit a stack of foil sheets separated from each other by the ribbon-like separator on the receptacle present in the stacking station is more than enough to remove the stack of foil sheets from the receptacle at the unloading station with adequate care and precision.

The Applicant has verified that the machine downtime between the formation of a stack of foil sheets and the next one is substantially given by only the time necessary to transfer the receptacles to the stacking station.

Preferably, when a receptacle of said plurality of receptacles is in the stacking station another receptacle of said plurality of receptacles is in the unloading station.

Preferably, a receptacle of said plurality of receptacles reaches the unloading station at the same time as another receptacle of said plurality of receptacles reaches the stacking station.

Preferably, the stacking station is placed closer to said feeder device of a continuous ribbon-like separator than the unloading station.

Preferably, there are provided a plurality of anchoring devices, each of which is active on a respective receptacle.

Preferably, each anchoring device is switchable between a retaining position in which it is configured to retain stacked foil sheets on a receptacle and a release position in which it does not retain stacked foil sheets on a receptacle.

Preferably, the anchoring device active on a receptacle is in the retaining position when said receptacle moves between the stacking station and the unloading station.

Preferably, the anchoring device active on a receptacle placed in the stacking station is in the release position at least when the first transfer device is in the release position.

Preferably, the anchoring device active on a receptacle placed in the stacking station is in the release position at least when the second transfer device is in the release position.

Preferably, a common transport path for the receptacles of said plurality of receptacles is defined.

Preferably, said stacking station and said unloading station are arranged along said transport path.

Preferably, all the receptacles move simultaneously along the transport path.

Preferably, when a receptacle reaches the stacking station, all the other receptacles interrupt their movement along the transport path.

Preferably, said plurality of receptacles comprises two receptacles.

In this case, preferably, when a first receptacle is in the stacking station, a second receptacle is in the unloading station and when the first receptacle is in the unloading station the second receptacle is in the stacking station.

Alternatively, preferably said plurality of receptacles comprises more than two receptacles.

In this case, there are preferably provided one or more transit stations, wherein the number of the transit stations is equal to the number of receptacles decreased by two.

Preferably, the transit stations may be interposed between the stacking station and the unloading station, or between the unloading station and the stacking station, or both between the stacking station and the unloading station and between the unloading station and the stacking station.

If there are transit stations, preferably when a receptacle is in the stacking station and another receptacle is in the unloading station, the remaining receptacles are in a corresponding transit station.

In any case, preferably said receptacles of said plurality of receptacles are equally spaced along said transport path.

Preferably, all the receptacles are equally spaced along the transport path both when they are arranged in their respective stacking, unloading and possibly transit stations, and when they move between one station and the next station.

Preferably, the transport path follows a closed trajectory.

Preferably, the closed trajectory is a circular trajectory.

Preferably, said circular trajectory starts and ends at the stacking station.

Preferably, there is provided a transport drum rotatable about a transport axis.

Preferably, the transport axis is rotated by an electric motor.

Preferably, each receptacle is mounted on said transport drum in order to rotate between the stacking station and the unloading station.

Preferably, in the case where there are provided transit stations, each receptacle is mounted on said transport drum in order to rotate between the stacking station, the unloading station and the transit stations.

Preferably, said transport axis is placed, with respect to said stacking station, on the opposite side with respect to said feeder device of a continuous ribbon-like separator.

Preferably, the actuating shaft is parallel to said transport axis of the transport drum.

Alternatively, said transport axis of the transport drum is arranged perpendicular to the rotation axes of the first accompanying roller and of the second accompanying roller.

Preferably, the actuating shaft and the transport axis are coincident with each other.

Alternatively, the transport axis is interposed between the stacking station and the actuating shaft.

Preferably, each receptacle comprises a respective stacking surface.

Preferably, said stacking surface is substantially flat.

Preferably, all the stacking surfaces lie on respective planes parallel to the transport axis of the transport drum.

Preferably, all the stacking surfaces lie on respective planes parallel to the transport axis of the transport drum both when the receptacles are in a respective station and when the receptacles are moving along the transport path.

Preferably, each anchoring device comprises a pair of anchoring fins hinged on said transport drum.

Preferably, said hinge axes are contained in respective planes perpendicular to said transport axis.

Preferably, said hinge axes are contained in respective planes perpendicular to said transport axis.

Preferably, each anchoring fin comprises a lip configured to be arranged parallel to the stacking surface of a respective receptacle when the anchoring device is in the retaining position.

Preferably, the pair of anchoring fins of each anchoring device are arranged on opposite sides of the respective receptacle along a direction parallel to the transport axis of the transport drum.

Preferably, the first retaining device and the second retaining device are active only on the receptacle placed in the stacking station.

Preferably, the receptacle placed in the stacking station is interposed between the first retaining device and the second retaining device.

Preferably, the accompanying device comprises at least one accompanying surface configured to contact the continuous ribbon-like separator.

Preferably, motorized members are active on the accompanying device to move the at least one accompanying surface while the accompanying device moves between the first end position and the second end position.

The Applicant thinks that in this way it is possible to further increase the production speed of the apparatus object of the present invention.

The Applicant has in fact noted that the time necessary to position the continuous ribbon-like separator above the cell being formed is determined by the acceleration to which an accompanying surface of an accompanying device is subjected and by the translation speed of the accompanying surface.

The Applicant has perceived that increasing the acceleration and the translation speed of the accompanying surface could decrease the time needed to position the continuous ribbon-like separator above the cell being formed in the stacking station.

The Applicant has however noted that this could cause a damage to or a tearing of the continuous ribbon-like separator. The Applicant has in fact verified that the moment of inertia of the accompanying surface can prevent, especially during high accelerations and decelerations, that the continuous ribbon-like separator can immediately drag the accompanying surface into rotation, with consequent different relative speed between the continuous ribbon-like separator and the accompanying surface and with consequent onset of sliding and friction forces that can damage or even tear the continuous ribbon-like separator.

The Applicant has found that by moving the accompanying surface with motorized members, the accompanying surface is able to accompany the continuous ribbon-like separator between the first end position and the second end position without inducing unwanted tensions, or in any case generating a few tensions, in the continuous ribbon-like separator, thus allowing high deposition speeds of the continuous ribbon-like separator on the cell being formed.

Preferably, it is provided to move the continuous ribbon-like separator above the stacking station between a first end position and a second end position and between a second end position and a first end position.

Preferably, moving the continuous ribbon-like separator above the stacking station comprises engaging the continuous ribbon-like separator with at least one accompanying surface.

Preferably, moving the continuous ribbon-like separator above the stacking station further comprises moving the at least one accompanying surface between the first end position and the second end position by imposing a predetermined first relative speed between the at least one accompanying surface and the continuous ribbon-like separator.

Preferably, the first relative speed is given by the difference between a first accompanying speed of the accompanying surface and a first displacement speed of the continuous ribbon-like separator between the first end position and the second end position.

Preferably, the magnitude of the first accompanying speed is greater than or equal to 80% of the magnitude of the first displacement speed.

Preferably, the magnitude of the first accompanying speed is greater than or equal to 85% of the magnitude of the first displacement speed.

Preferably, the magnitude of the first accompanying speed is greater than or equal to 90% of the magnitude of the first displacement speed.

Preferably, the magnitude of the first accompanying speed is greater than or equal to 95% of the magnitude of the first displacement speed.

Preferably, the magnitude of the first accompanying speed is greater than or equal to 98% of the magnitude of the first displacement speed.

Preferably, the magnitude of the first accompanying speed is less than or equal to 120% of the magnitude of the first displacement speed.

Preferably, the magnitude of the first accompanying speed is less than or equal to 115% of the magnitude of the first displacement speed.

Preferably, the magnitude of the first accompanying speed is less than or equal to 110% of the magnitude of the first displacement speed.

Preferably, the magnitude of the first accompanying speed is less than or equal to 105% of the magnitude of the first displacement speed.

Preferably, the magnitude of the first accompanying speed is less than or equal to 102% of the magnitude of the first displacement speed.

Preferably, the magnitude of the first accompanying speed is comprised between 80% and 120% of the magnitude of the first displacement speed.

Preferably, the magnitude of the first accompanying speed is comprised between 90% and 110% of the magnitude of the first displacement speed.

Preferably, the magnitude of the first accompanying speed is comprised between 95% and 105% of the magnitude of the first displacement speed.

Preferably, the magnitude of the first accompanying speed is comprised between 98% and 112% of the magnitude of the first displacement speed.

Preferably, the magnitude of the first accompanying speed is equal to the magnitude of the first displacement speed.

Preferably said at least one accompanying surface rolls without sliding with respect to the continuous ribbon-like separator.

Preferably, said at least one accompanying surface is configured to rotate while the accompanying device moves between the first end position and the second end position.

Preferably, it is provided to stop the rotation of the accompanying surface when the accompanying surface reaches the second end position.

Preferably, it is provided to stop the rotation of the accompanying surface when the accompanying surface is in the first end position.

Preferably, said accompanying device comprises a first accompanying roller having an outer surface defining said at least one accompanying surface.

Preferably, it is provided to accelerate in rotation the first accompanying roller with a first angular acceleration up to a first angular speed when the first accompanying roller starts moving towards the second end position.

Preferably, the motorized members are configured to accelerate in rotation the first accompanying roller with a first angular acceleration up to a first angular speed when the first accompanying roller starts moving towards the second end position.

Preferably, it is provided to stop the rotation of the first accompanying roller when the first accompanying roller is in the first end position.

Preferably, the motorized members are configured to stop the rotation of the first accompanying roller when the first accompanying roller is in the first end position.

Preferably, the accompanying device moves between the second end position and the first end position and above the stacking station when the first transfer device moves from the release position to the pick-up position.

Preferably, the accompanying device comprises a further accompanying surface.

Preferably, moving the continuous ribbon-like separator above the stacking station further comprises engaging the continuous ribbon-like separator with a further accompanying surface.

Preferably, the further accompanying surface is configured to contact the continuous ribbon-like separator.

Preferably, moving the continuous ribbon-like separator above the stacking station further comprises moving said further accompanying surface between the second end position and the first end position by imposing a second predetermined relative speed between the further accompanying surface and the continuous ribbon-like separator.

The Applicant has verified that this second relative speed can be set in such a way as to accompany the continuous ribbon-like separator between the second end position and the first end position without inducing unwanted tensions, or in any case generating a few tensions, in the continuous ribbon-like separator, even in the passage of the continuous ribbon-like separator between the second end position and the first end position.

Preferably, said second relative speed is given by the difference between a second accompanying speed of the further accompanying surface and a second displacement speed of the continuous ribbon-like separator between the second end position and the first end position.

Preferably, the magnitude of the second accompanying speed is greater than or equal to 80% of the magnitude of the second displacement speed.

Preferably, the magnitude of the second accompanying speed is greater than or equal to 85% of the magnitude of the second displacement speed.

Preferably, the magnitude of the second accompanying speed is greater than or equal to 90% of the magnitude of the second displacement speed.

Preferably, the magnitude of the second accompanying speed is greater than or equal to 95% of the magnitude of the second displacement speed.

Preferably, the magnitude of the second accompanying speed is greater than or equal to 98% of the magnitude of the second displacement speed.

Preferably, the magnitude of the second accompanying speed is less than or equal to 120% of the magnitude of the second displacement speed.

Preferably, the magnitude of the second accompanying speed is less than or equal to 115% of the magnitude of the second displacement speed.

Preferably, the magnitude of the second accompanying speed is less than or equal to 110% of the magnitude of the second displacement speed.

Preferably, the magnitude of the second accompanying speed is less than or equal to 105% of the magnitude of the second displacement speed.

Preferably, the magnitude of the second accompanying speed is less than or equal to 102% of the magnitude of the second displacement speed.

Preferably, the module of the second accompanying speed is comprised between 80% and 120% of the module of the second displacement speed.

Preferably, the module of the second accompanying speed is comprised between 90% and 110% of the module of the second displacement speed.

Preferably, the module of the second accompanying speed is comprised between 95% and 105% of the module of the second displacement speed.

Preferably, the module of the second accompanying speed is comprised between 98% and 112% of the module of the second displacement speed.

Preferably, the magnitude of the second accompanying speed is equal to the magnitude of the second displacement speed.

Preferably, the magnitude of the second accompanying speed is equal to the magnitude of the first accompanying speed.

Preferably said further accompanying surface rolls without sliding with respect to the continuous ribbon-like separator.

Preferably, the motorized members are configured to move the further accompanying surface while the accompanying device moves between the second end position and the first end position.

The Applicant has found that by providing a further accompanying surface set in motion by the motorized members, the further accompanying surface is able to accompany the continuous ribbon-like separator without inducing unwanted tensions, or in any case generating a few tensions, in the continuous ribbon-like separator even in the passage of the continuous ribbon-like separator between the second end position and the first end position.

Preferably, it is provided to stop the rotation of the further accompanying surface when the further accompanying surface reaches the first end position.

Preferably, it is provided to stop the rotation of the further accompanying surface when the further accompanying surface is in the second end position.

Preferably, said accompanying device comprises a second accompanying roller having an outer surface defining said further accompanying surface.

Preferably, it is provided to stop the rotation of the second accompanying roller when the second accompanying roller is in the second end position.

Preferably, said motorized members are configured to stop the rotation of the second accompanying roller when the second accompanying roller is in the second end position.

Preferably, it is provided to accelerate in rotation the second accompanying roller with a second angular acceleration up to a second angular speed when the second accompanying roller starts moving towards the first end position.

Preferably, said motorized members are configured to accelerate in rotation the second accompanying roller with a second angular acceleration up to a second angular speed when the second accompanying roller starts moving towards the first end position.

Preferably, the first accompanying roller and the second accompanying roller are counter-rotating to each other.

Preferably, said first angular speed has a magnitude equal to the magnitude of said second angular speed and a direction opposite to the direction of said second angular speed.

Preferably, the time during which the first accompanying roller is rotated at the first angular speed is equal to the time during which the second accompanying roller is rotated at the second angular speed.

Preferably, the instant of start of the rotation of the first accompanying roller at the first angular speed coincides with the instant of start of the rotation of the second accompanying roller at the second angular speed.

Preferably, said first angular acceleration has a magnitude equal to said second angular acceleration.

Preferably, the time during which the first accompanying roller is rotated at the first angular acceleration is equal to the time during which the second accompanying roller is rotated at the second angular acceleration.

Preferably, the instant of start of the rotation of the first accompanying roller at the first angular acceleration coincides with the instant of start of the rotation of the second accompanying roller at the second angular acceleration.

Preferably, the first accompanying roller and the second accompanying roller comprise, respectively, a rotation axis.

Preferably, the rotation axis of the first accompanying roller is parallel to the rotation axis of the second accompanying roller.

Preferably, said transport axis of the transport drum is arranged parallel to the rotation axes of the first accompanying roller and of the second accompanying roller.

Alternatively, said transport axis of the transport drum is arranged perpendicular to the rotation axes of the first accompanying roller and of the second accompanying roller.

Preferably, the outer surface of the first accompanying roller defines a rest surface for the continuous ribbon-like separator.

Preferably, the outer surface of the second accompanying roller defines a rest surface for the continuous ribbon-like separator.

Preferably, the outer surface of the first accompanying roller and of the second accompanying roller are spaced by a radius distance from the respective rotation axes.

Preferably, said first accompanying speed of the accompanying surface is equal to said first angular speed of the first accompanying roller multiplied by the radius distance of the first accompanying roller.

Preferably, said second accompanying speed of the further accompanying surface is equal to said second angular speed of the second accompanying roller multiplied by the radius distance of the second accompanying roller.

Preferably, the radius distance of the first accompanying roller is equal to the radius distance of the second accompanying roller.

Preferably, a distance separating the rotation axis of the first accompanying roller from the rotation axis of the second accompanying roller is greater than the sum of the radius distance of the first accompanying roller and of the radius distance of the second accompanying roller.

Preferably, the distance separating the rotation axis of the first accompanying roller from the rotation axis of the second accompanying roller is equal to or greater than the sum of the radius distance of the first accompanying roller, of the radius distance of the second accompanying roller and of the thickness of the continuous ribbon-like separator.

Preferably, in the passage between the first end position and the second end position the rotation axis of the first accompanying roller moves along a first trajectory.

Preferably, in the passage between the first end position and the second end position the rotation axis of the first accompanying roller moves at a first displacement speed along said first trajectory.

Preferably, in the passage between the second end position and the first end position the rotation axis of the first accompanying roller moves along a second trajectory.

Preferably, in the passage between the second end position and the first end position the rotation axis of the first accompanying roller moves at a second displacement speed along said second trajectory.

Preferably, in the passage between the first end position and the second end position the rotation axis of the second accompanying roller moves along a first trajectory.

Preferably, in the passage between the first end position and the second end position the rotation axis of the second accompanying roller moves at a first displacement speed along the first trajectory.

Preferably, in the passage between the second end position and the first end position the rotation axis of the second accompanying roller moves along a second trajectory.

Preferably, in the passage between the second end position and the first end position the rotation axis of the second accompanying roller moves at a second displacement speed along the second trajectory.

Preferably, the first trajectory followed by the rotation axis of the first accompanying roller at least partially coincides with the first trajectory followed by the rotation axis of the second accompanying roller.

Preferably, the second trajectory followed by the rotation axis of the first accompanying roller at least partially coincides with the second trajectory followed by the rotation axis of the second accompanying roller.

Preferably, the first trajectory followed by the rotation axis of the first accompanying roller at least partially coincides with the second trajectory followed by the rotation axis of the first accompanying roller.

Preferably, the first trajectory followed by the rotation axis of the second accompanying roller at least partially coincides with the second trajectory followed by the rotation axis of the second accompanying roller.

Preferably, the magnitude of the first displacement speed of the rotation axis of the first accompanying roller is equal to the magnitude of the second displacement speed of the rotation axis of the first accompanying roller.

Preferably, the magnitude of the first displacement speed of the rotation axis of the second accompanying roller is equal to the magnitude of the second displacement speed of the rotation axis of the second accompanying roller.

Preferably, the magnitude of the first displacement speed of the rotation axis of the first accompanying roller is equal to the magnitude of the first displacement speed of the rotation axis of the second accompanying roller.

Preferably, the magnitude of the second displacement speed of the rotation axis of the first accompanying roller is equal to the magnitude of the second displacement speed of the rotation axis of the second accompanying roller.

Preferably, said motorized members comprise at least one electric motor connected to the accompanying device.

Preferably, said motorized members comprise a single electric motor connected to the first accompanying roller and to the second accompanying roller.

Alternatively, said motorized members comprise a first electric motor connected to the first accompanying roller and a second electric motor connected to the second accompanying roller.

Preferably, said motorized members comprise a motorized pulley, a first pulley integral in rotation to the first accompanying roller and a second pulley integral in rotation to the second accompanying roller.

Preferably, there is provided only one motorized pulley.

Preferably, said motorized members comprise a drive belt that engages the motorized pulley, the first pulley and the second pulley.

Preferably, the first accompanying roller and the second accompanying roller are driven in rotation simultaneously by the drive belt.

Preferably, by providing the radius distance of the first accompanying roller equal to the radius distance of the second accompanying roller, it is possible to drive in rotation the first accompanying roller and the second accompanying roller with identical angular speed and angular acceleration moduli with a single drive belt.

Preferably, the drive belt comprises a first surface and a second surface opposite and parallel to the first surface.

Preferably, the first surface is a continuous radially inner surface of the drive belt. Preferably, the second surface is a radially outer and continuous surface of the drive belt.

Preferably, the first surface of the drive belt engages the motorized pulley and the first pulley.

Preferably, the second surface of the drive belt engages the second pulley.

In this way, the drive belt rotates the first accompanying roller and the second accompanying roller in a manner counter-rotating to each other.

Preferably, said motorized members comprise a single motorized shaft on which the motorized pulley is keyed.

Preferably, said motorized shaft is parallel to the rotation axis of the first accompanying roller and of the second accompanying roller.

Further characteristics and advantages of the present invention will become clearer from the following detailed description of a preferred embodiment thereof, with reference to the appended drawings and provided by way of indicative and non-limiting example, in which:

### BRIEF DESCRIPTION OF THE DRAWINGS

FIGS. 1 to 4 are schematic views of a stacking apparatus for alternately stacking a continuous ribbon-like separator and foil sheets in accordance with the present invention under different operating conditions;

FIG. 5 is a schematic perspective view of some components of the stacking apparatus for alternately stacking a continuous ribbon-like separator and foil sheets of FIG. 1;

FIG. 6 is a schematic front view of some components of the stacking apparatus for alternately stacking a continuous ribbon-like separator and foil sheets of FIG. 1;

FIG. 7 is a schematic perspective view of some components of the stacking apparatus for alternately stacking a continuous ribbon-like separator and foil sheets of FIG. 1; and

FIG. 8 is a schematic perspective view of some components of the stacking apparatus for alternately stacking a continuous ribbon-like separator and foil sheets of FIG. 1.

### DETAILED DESCRIPTION

The representations in the accompanying figures do not necessarily have to be understood in scale and do not necessarily respect the proportions between the various parts.

The apparatus 1 is preferably used to make electrochemical cells, for example secondary electrochemical cells, comprising flat electrodes separated from each other by a continuous dielectric separator.

The apparatus 1 comprises a support frame 9 on which the various components of the apparatus 1 are mounted.

The apparatus 1 comprises a first transfer device 10 for transferring first foil sheets 100 and a second transfer device 11 for transferring second foil sheets 101.

The first foil sheets 100 and the second foil sheets 101 are configured to make electrodes of an electrochemical cell.

For example, the first foil sheets 100 may be foil sheets of metallic material intended to make the anode of an electrochemical cell. For example, the first foil sheets 100 may be copper sheets.

The second foil sheets 101 may be foil sheets of metallic material intended to make the cathode of an electrochemical cell. For example, the second foil sheets 101 may be aluminium sheets.

Alternatively, the first foil sheets 100 may be foil sheets of metallic material intended to make the cathode of an electrochemical cell.

In this case, the second foil sheets 101 may be foil sheets of metallic material intended to make the anode of an electrochemical cell. In this case, the first foil sheets 100 may for example be aluminium sheets and the second foil sheets 101 may for example be copper sheets.

The first transfer device 10 comprises, in the preferred embodiment of the invention, a transfer plate 12 configured to contact and retain a first foil sheet 100. The transfer plate 12 may for example comprise a suction device or suction cups (not illustrated) to allow a first foil sheet 100 to be retained.

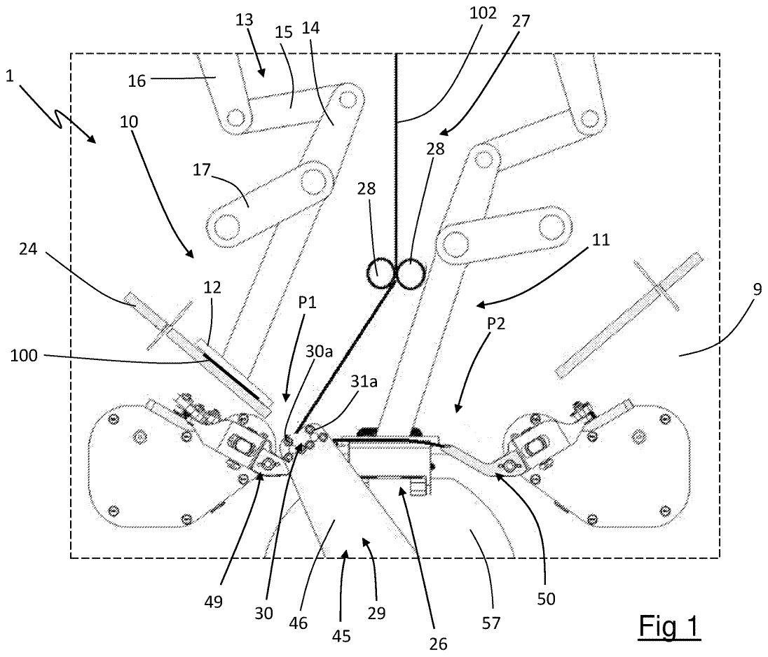

As schematized in FIG. 1, the first transfer device 10 further comprises a linkage 13 connected to the transfer plate 12 for moving the transfer plate 12. The a linkage 13 comprises a command connecting rod 14 having a first end connected to the transfer plate 12 and a second end hinged to a connecting rod 15. The connecting rod 15 is also hinged to a crank 16 connected to an electric motor (not illustrated). The command connecting rod 14 is also hinged, in a position comprised between its two ends, to a rocker 17 in turn hinged to the frame 9. The length of the command connecting rod 14, of the connecting the rod 15, of the rocker 17 and of the crank 16, as well as the hinge points between these components define the trajectory that the transfer plate 12 can perform.

Similarly, the second transfer device 11 comprises, in the preferred embodiment of the invention, a transfer plate 18 configured to contact and retain a second foil sheet 101. The transfer plate 18 may for example comprise a suction device or suction cups (not illustrated) to allow a second foil sheet 101 to be retained.

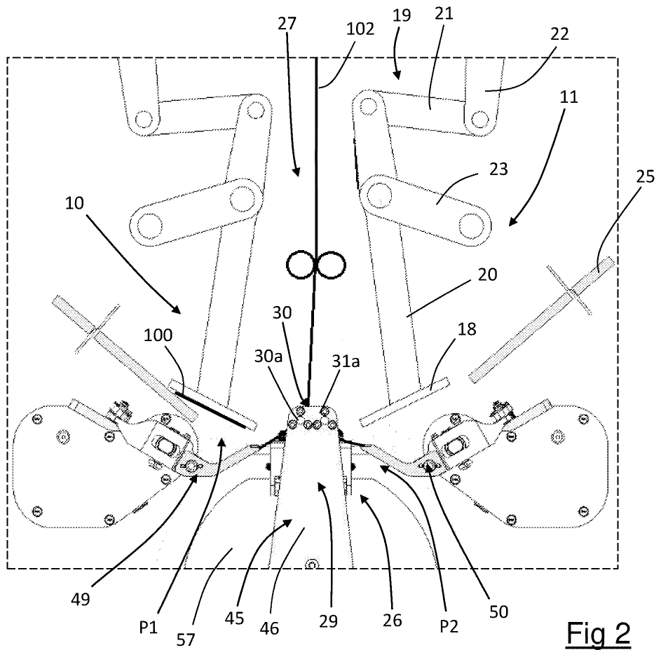

The second transfer device 11 further comprises (FIG. 2) a linkage 19 connected to the transfer plate 18 for moving the transfer plate 18. The a linkage 19 comprises a command connecting rod 20 having a first end connected to the transfer plate 18 and a second end hinged to a connecting rod 21. The connecting rod 21 is also hinged to a crank 22 connected to an electric motor (not illustrated). The command connecting rod 20 is also hinged, in a position comprised between its two ends, to a rocker 23 in turn hinged to the frame 9. The length of the command connecting rod 20, of the connecting the rod 21, of the rocker 23 and of the crank 22, as well as the hinge points between these components define the trajectory that the transfer plate 18 can perform.

The first foil plates 100 are fed to the first transfer device 10 by a first plate feeder 24 (FIG. 1). The first plate feeder 24 may contain first foil plates 100 stacked between them or, preferably, may be configured to feed a continuous ribbon from which the first foil plates 100 are cut to size one after the other. In particular, only a first foil plate 100 at a time is cut from the continuous ribbon, so that the first transfer device 10 can act on the cut first foil plate 100 before a further first plate 100 is cut.

Similarly, the second foil plates 101 are fed to the second transfer device 11 by a second plate feeder 25 (FIG. 2). The second plate feeder 25 may contain second foil plates 101 stacked between them or, preferably, may be configured to feed a continuous ribbon from which the second foil plates 101 are cut to size one after the other. In particular, only one second foil plate 101 at a time is cut from the ribbon, so that the second transfer device 11 can act on the cut second foil plate 101 before a further second foil plate 101 is cut.

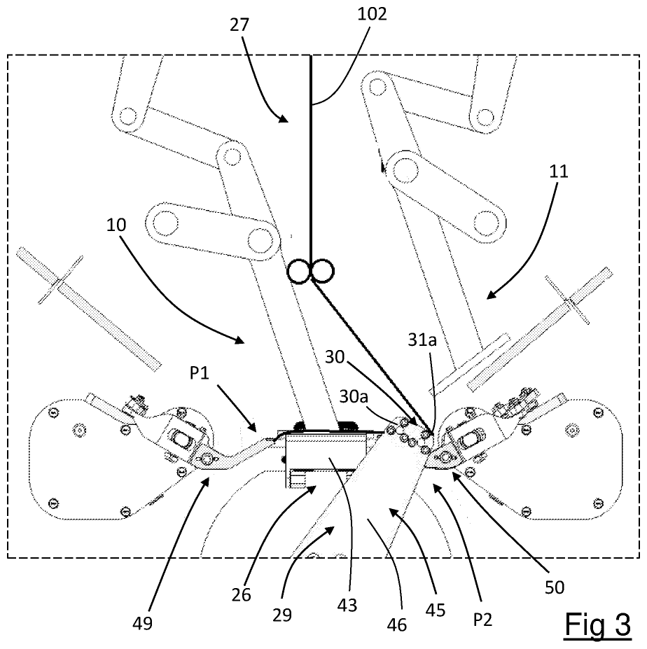

The first transfer device 10 is movable between a pick-up position (illustrated in FIG. 1) and a release position (illustrated in FIG. 3). In the pick-up position, the transfer plate 12 is substantially placed at the first plate feeder 24 and in contact with a first foil plate 100.

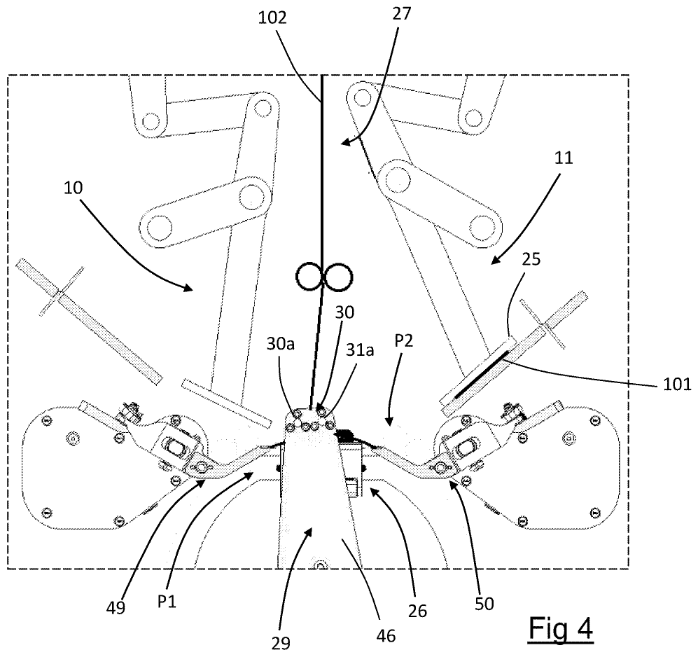

The second transfer device 11 is movable between a pick-up position (illustrated in FIG. 4) and a release position (illustrated in FIG. 1). In the pick-up position, the transfer plate 18 is substantially placed at the second plate feeder 25 and in contact with a second foil plate 101.

The apparatus 1 comprises a stacking station 26 placed between the first transfer device 10 and the second transfer device 11.

When the first transfer device 10 is in the release position, the transfer plate 12 is placed at the stacking station 26 to deposit the first foil plate 100 transported in the stacking station 26.

Similarly, when the second transfer device 11 is in the release position, the transfer plate 18 is placed at the stacking station 26 to deposit the second foil plate 101 transported in the stacking station 26.

As schematized in FIGS. 1 to 4, the first transfer device 10 and the second transfer device 11 move substantially in counterphase. In particular, the first transfer device 10 and the second transfer device 11 are never both in the respective release positions. When the first transfer device 10 is in the release position, the second transfer device 11 is in the pick-up position, or is moving between the pick-up position and the release position (as for example schematized in FIG. 3). When the second transfer device 11 is in the release position, the first transfer device 10 is in the pick-up position (as for example schematized in FIG. 3), or is moving between the pick-up position and the release position. It should be noted that since the first transfer device 10 and the second transfer device 11 remain in the release position for a time necessary to release the respective foil plate in the stacking station 26, when a transfer device is in the respective release position, the other transfer device moves toward and reaches the respective pick-up position.

The continuous movement of the first transfer device 10 and of the second transfer device 11 from the respective pick-up positions to the respective release positions (and from the respective release positions to the respective pick-up positions) results in the formation of a stack of first foil plates 100 and of second foil plates 101 alternately overlapping on each other in the stacking station 26.

As schematized in FIGS. 1 to 4, the apparatus 1 further comprises a feeder device 27 of a continuous ribbon-like separator 102 configured to feed a continuous ribbon-like separator 102 towards the stacking station 26.

The feeder device 27 is placed between the first transfer device 10 and the second transfer device 11 and above the stacking station 26.

The feeder device 27 comprises a rotating support (not illustrated) for a continuous ribbon-like separator coil 102 and a pair of feed rollers 28 through which the continuous ribbon-like separator 102 is unwound towards the stacking station 26. The pair of feed rollers 28 can be rotated by an electric motor (not illustrated) and can be configured to move towards and away from each other (for example during the operations of inserting the continuous ribbon-like separator 102 between the feed rollers 28). The pair of feed rollers 28 is placed at a predetermined distance from the stacking station 26 preferably above a central area of the stacking station 26, as schematized in FIG. 1.

The apparatus 1 comprises a displacement device 29 configured to operate on the continuous ribbon-like separator 102 fed by the feeder device 27.

The displacement device 29 operates at the stacking station 26 and is arranged between the first transfer device 10 and the second transfer device 11. The displacement device 29 has the function of positioning the continuous ribbon-like separator 102 between the first and second foil plates that are deposited in the stacking station 26. The displacement device 29 is physically and functionally distinct from the first transfer device 10 and from the second transfer device 11.

The continuous ribbon-like separator 102 has the function of keeping the first foil plates 100 and the second foil plates 101 physically separated to avoid short circuits between them, nonetheless allowing an ion transport between the first foil plates 100 and the second foil plates 101.

The resulting electrochemical cell is of the “bag” or “prismatic” type. Unlike cylindrical winding batteries, the batteries that use a bag or prismatic cell do not use the “jelly roll” type winding method but use the “Z-folding” technique in which the continuous ribbon-like separator 102 is evenly zigzag stacked around the anode (for example the first foil sheets 100) and the cathode (for example the second foil sheets 101).

The displacement device 29 comprises an accompanying device 30 movable with reciprocating motion between a first end position P1 (FIG. 1) and a second end position P2 (FIG. 3). The first end position P1 is placed between the stacking station 26 and the first transfer device 10 and the second end position P2 is placed between the stacking station 26 and the second transfer device 10. The stacking station 26 then develops between the first end position P1 and the second end position P2 of the accompanying device 30.

The accompanying device 30 comprises an accompanying surface 31 configured to contact the continuous ribbon-like separator 102 and to accompany it in the movement between the first end position P1 and the second end position P2.

The accompanying device 30 further comprises a further accompanying surface 32 configured to contact the continuous ribbon-like separator 102 and to accompany it in the movement between the second end position P2 and the first end position P1.

The accompanying device 30 is motorized by motorized members 34 in such a way as to actively set in motion the first accompanying surface 31 and the second accompanying surface 32. In particular, the accompanying device 30 is motorized in such a way as to actively rotate the first accompanying surface 31 and the second accompanying surface 32. The motorized members 34 are distinct and different from the first transfer device 10. The motorized members 34 are distinct and different from the second transfer device 11.

In the preferred embodiment of the invention, the accompanying device 30 comprises a first accompanying roller 30a and a second accompanying roller 31a.

The first accompanying roller 30a and the second accompanying roller 31a are movable with reciprocating motion between the first end position P1 and the second end position P2.

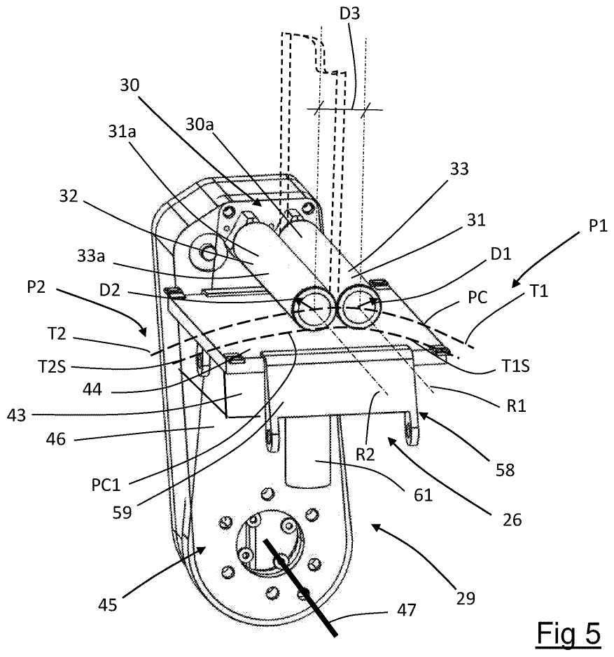

As better illustrated in FIG. 5, the first accompanying roller 30a and the second accompanying roller 31a comprise a respective rotation axis R1, R2.

The rotation axis R1 of the first accompanying roller 30a is parallel to the rotation axis R2 of the second accompanying roller 31a.

The first accompanying roller 30a and the second accompanying roller 31a comprise a respective outer surface 33, 33a. The outer surfaces 33, 33a of the first accompanying roller 30a and of the second accompanying roller 31a are preferably without surface roughness and are preferably smooth.

The outer surface 33 of the first accompanying roller 30a defines the accompanying surface 31 and the outer surface 33a of the second accompanying roller 31a defines the further accompanying surface 32 of the accompanying device 30.

The outer surface 33 of the first accompanying roller 30a is spaced by a radius distance D1 from the rotation axis R1 of the first accompanying roller 30a.

The outer surface 33a of the second accompanying roller 31a is spaced by a radius distance D2 from the rotation axis R2 of the second accompanying roller 31a.

The radius distance D1 of the first accompanying roller 30a is equal to the radius distance D2 of the second accompanying roller 31a.

The rotation axis R1 of the first accompanying roller 30a is spaced from the rotation axis R2 of the second accompanying roller 31a by a distance D3 that is substantially equal to the sum of the radius distance D1 of the first accompanying roller 30a, of the radius distance D2 of the second accompanying roller 31a, and of the thickness of the continuous ribbon-like separator 102, as schematized in FIG. 5 (where the continuous ribbon-like separator is illustrated with a dashed line).

The continuous ribbon-like separator 102 is inserted between the first accompanying roller 30a and the second accompanying roller 31a and is preferably in contact with both the outer surface 33 of the first accompanying roller 30a and the outer surface 33a of the second accompanying roller 31a.

The rotation axis R1 of the first accompanying roller 30a and the rotation axis R2 of the second accompanying roller 31a always remain at the same mutual distance D3 during the passage of the first accompanying roller 30a and of the second accompanying roller 31a between the first end position P1 and the second end position P2 and between the second end position P2 and the first end position P1.

When the first accompanying roller 30a and the second accompanying roller 31a move between the first end position P1 and the second end position P2, the first accompanying roller 30a and the second accompanying roller 31a unwind the continuous ribbon-like separator 102 on the stacking station 26 and in particular on the foil sheet just deposited by the first transfer device 10 or by the second transfer device 11.

In the passage between the first end position P1 and the second end position P2, the first accompanying roller 30a and the second accompanying roller 31a (and in particular the respective rotation axes R1, R2) move along a respective first trajectory T1 in which said first trajectories are substantially coincident (FIG. 5).

In the passage between the second end position P2 and the first end position P1, the first accompanying roller 30a and the second accompanying roller 31a (and in particular the respective rotation axes R1, R2) move along a respective second trajectory T2 in which said second trajectories are substantially coincident (FIG. 5).

In the passage between the first end position P1 and the second end position P2 the rotation axis R1 of the first accompanying roller 30a moves at a first displacement speed V1 along the first trajectory T1.

In the passage between the second end position P2 and the first end position P1 the rotation axis R1 of the first accompanying roller 30a moves at a second displacement speed V2 along the second trajectory T2.

In the passage between the first end position P1 and the second end position P2, the rotation axis R2 of the second accompanying roller 31a moves at a first displacement speed V3 along the first trajectory T1.

In the passage between the second end position P2 and the first end position P1 the rotation axis R2 of the second accompanying roller 31a moves at a second displacement speed V4 along the second trajectory T2.

The first displacement speed V1 is equal to the third displacement speed V3 and the second displacement speed V2 is equal to the fourth displacement speed V4.

The moduli of the first displacement speed V1, the third displacement speed V3, the second displacement speed V2, and the fourth displacement speed V4 are equal to each other.

Such first and second trajectories T1, T2 are more specifically given by the location of the points traversed by the rotation axes R1, R2 of the first accompanying roller 30a and of the second accompanying roller 31a in the displacement, respectively, between the first end position P1 and the second end position P2 and between the second end position P2 and the first end position P1.

As represented in FIG. 5, these first and second trajectories T1, T2 define a curved path PC followed by the first accompanying roller 30a and the second accompanying roller 31a. This curved path PC has a concavity facing the stacking station 26.

The path followed by the continuous ribbon-like separator 102 during its deposition on the stacking station 26 between the first end position P1 and the second end position P2 also follows a first trajectory T1S. The path followed by the continuous ribbon-like separator 102 during its deposition on the stacking station 26 between the second end position P2 and the first end position P1 follows a second trajectory T2S. Both the first trajectory T1S and the second trajectory T2S followed by the continuous ribbon-like separator 102 during its deposition on the stacking station 26 are curved trajectories. The first trajectory T1S and the second trajectory T2S are coincident.

Therefore, the path followed by the continuous ribbon-like separator 102 during its deposition on the stacking station 26 between the first end position P1 and the second end position P2 and between the second end position P2 and the first end position P1 and above the last foil sheet deposited is also a curved path PC1 having a concavity facing the stacking station 26.

From a strictly geometric point of view, the curved path PC1 followed by the continuous ribbon-like separator 102 is parallel to the curved path PC followed by the rotation axes R1, R2 of the first accompanying roller 30a and of the second accompanying roller 31a, however for the purposes of the present invention these two curved paths can be considered substantially coincident.

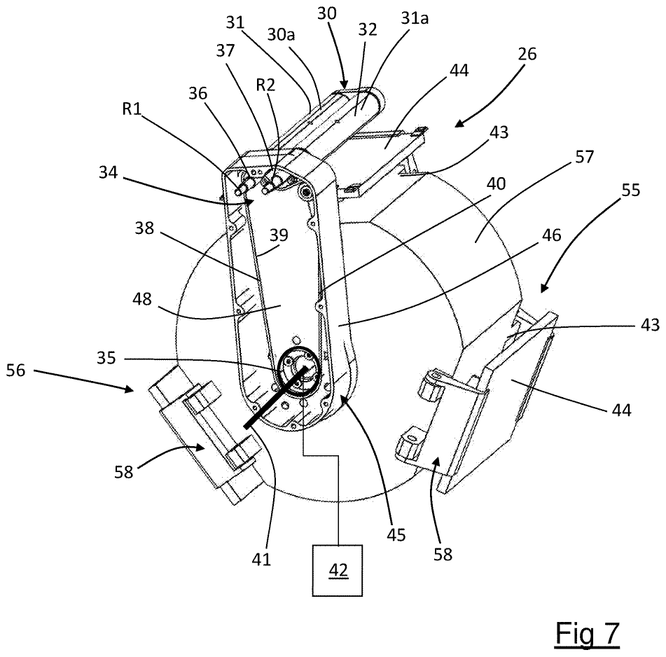

The first accompanying roller 30a and the second accompanying roller 31a are rotated about the respective rotation axes R1, R2 by the motorized members 34 (represented in FIG. 7). The first accompanying roller 30a and the second accompanying roller 31a are rotated about the respective rotation axes R1, R2 in such a way as to make the first accompanying roller 30a and the second accompanying roller 31a counter-rotating to each other.

In a possible embodiment of the motorized members illustrated in FIG. 7, the motorized members 34 comprise a motorized pulley 35, a first pulley 36 integral in rotation with the first accompanying roller 30a and a second pulley 37 integral in rotation with the second accompanying roller 31a.

The first pulley 36 is keyed on the rotation axis R1 of the first accompanying roller 30a and the second pulley 36 is keyed on the rotation axis R2 of the second accompanying roller 31a.

The motorized members 34 further comprise a drive belt 38 that engages the motorized pulley 35, the first pulley 36 and the second pulley 37. The drive belt 38 is set in motion by the motorized pulley 35 and drives both the first accompanying roller 30a and the second accompanying roller 31a.

The drive belt 38 has a first surface 39 and a second surface 40 which are closed into a ring and parallel, wherein the first surface 39 is radially internal to the second surface 40.

The first surface 39 and the second surface 40 of the drive belt 38 may be toothed to mesh respective toothings of the motorized pulley 35 of the first pulley 36 and of the second pulley 37.

In particular, as represented in FIG. 7, the first surface 39 of the drive belt 38 engages the motorized pulley 35 and the first pulley 36, while the second surface 40 of the drive belt 38 engages the second pulley 37, obtaining opposite rotations of the first accompanying roller 30a and of the second accompanying roller 31a when the drive belt 38 is set in motion. In this regard, the motorized pulley 35 is rotated by a motorized shaft 41 (schematized in FIG. 7) parallel to the rotation axes R1, R2 of the first accompanying roller 30a and of the second accompanying roller 31a.

The motorized shaft 41 is commanded in rotation by an electric motor (schematized with the number 42 in FIG. 7) driven in such a way as to stop the rotation of the first accompanying roller 30a and of the second accompanying roller 31a when the latter are in the first end position P1 and when they are in the second end position P2.

When the continuous ribbon-like separator 102 is moved above the stacking station 26, the accompanying surface 31 is moved, while the accompanying device 30 moves between the first end position P1 and the second end position P2, imposing a predetermined first relative speed between the accompanying surface 31 and the continuous ribbon-like separator 102.

This first relative speed is given by the difference between a first accompanying speed of the accompanying surface 31 and a first displacement speed of the continuous ribbon-like separator 102 between the first end position P1 and the second end position P2.

This first relative speed is chosen in such a way as to cancel or in any case minimize relative slippages between the continuous ribbon-like separator 102 and the accompanying surface 31.

Similarly, when the continuous ribbon-like separator 102 is moved above the stacking station 26, the further accompanying surface 32 is moved, while the accompanying device 30 moves between the second end position P2 and the first end position P1, imposing a second predetermined relative speed between the further accompanying surface 32 and the continuous ribbon-like separator 102.

This second relative speed is given by the difference between a second accompanying speed of the further accompanying surface 32 and a second displacement speed of the continuous ribbon-like separator 102 between the second end position P2 and the first end position P1.

This second relative speed is chosen in such a way as to cancel or in any case minimize relative slippages between the continuous ribbon-like separator 102 and the further accompanying surface 32.

In this regard, in the preferred embodiment of the invention, the electric motor 42 is driven to accelerate in rotation the first accompanying roller 30a and the second accompanying roller 31a with a first angular acceleration AC1 up to a first angular speed VA1 when the first accompanying roller 30a starts moving from the first end position P1 towards the second end position P2. The first angular acceleration AC1 of the first accompanying roller 30a is equal in magnitude to the magnitude of the first angular acceleration AC1 of the second accompanying roller 31a. The first angular speed VA1 of the first accompanying roller 30a is equal in magnitude and opposite in direction to the first angular speed VA1 of the second accompanying roller 31a.

The electric motor 42 is also driven to accelerate in rotation the first accompanying roller 30a and the second accompanying roller 31a with a second angular acceleration AC2 up to a second angular speed VA2 when the first accompanying roller 30a starts moving from the second end position P2 towards the first end position P1. The second angular acceleration AC2 of the first accompanying roller 30a is equal in magnitude to the magnitude of the second angular acceleration AC2 of the second accompanying roller 31a. The second angular speed VA2 of the first accompanying roller 30a is equal in magnitude and opposite in direction to the second angular speed VA2 of the second accompanying roller 31a.

The first angular acceleration AC1 of the first accompanying roller 30a is equal in magnitude to the magnitude of the second angular acceleration AC2 of the first accompanying roller 30a. The first angular speed VA1 of the first accompanying roller 30a is equal in magnitude and opposite in direction to the second angular speed VA2 of the first accompanying roller 30a.

The first angular acceleration AC1 of the second accompanying roller 31a is equal in magnitude to the magnitude of the second angular acceleration AC2 of the second accompanying roller 31a. The first angular speed VA1 of the second accompanying roller 31a is equal in magnitude and opposite in direction to the second angular speed VA2 of the second accompanying roller 31a.

In alternative embodiments not illustrated, the motorized members 34 may alternatively comprise a pair of electric motors wherein each electric motor commands in rotation the rotation axis R1, R2 of the first accompanying roller 30a and of the second accompanying roller 31a. In this case, the drive of the two electric motors is driven by a control unit in such a way as to obtain the described angular speeds and angular accelerations of the first accompanying roller 30a and of the second accompanying roller 31a.

The first accompanying speed of the accompanying surface 31 is equal to the first angular speed VA1 of the first accompanying roller 30a multiplied by the radius distance D1 of the first accompanying roller 30a.

The second accompanying speed of the further accompanying surface 32 is equal to the second angular speed VA2 of the second accompanying roller 31a multiplied by the radius distance D2 of the second accompanying roller 31a.

In other words, the first angular speed VA1 of the first accompanying roller 30a is set in such a way as to cancel or in any case minimize relative slippages between the continuous ribbon-like separator 102 and the outer surface 33 of the first accompanying roller 30a.

Similarly, the second angular speed VA2 of the second accompanying roller 31a is set in such a way as to cancel or in any case minimize relative slippages between the continuous ribbon-like separator 102 and the outer surface 33a of the second accompanying roller 31a.

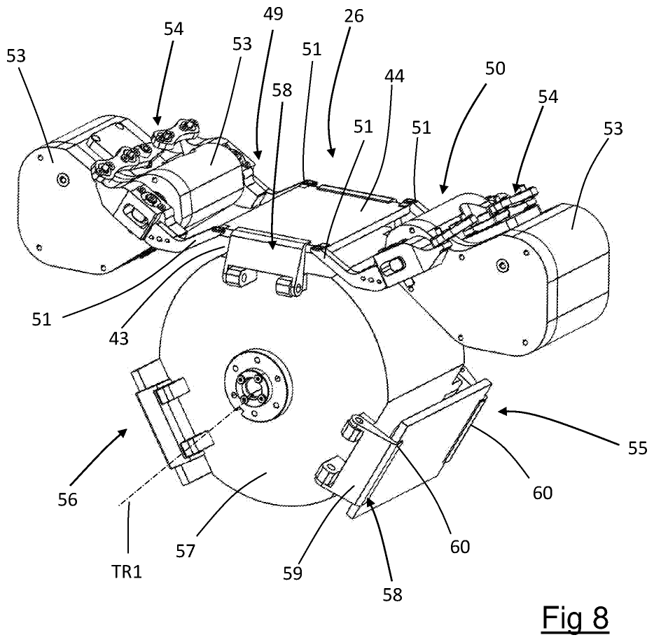

As schematically indicated in FIGS. 7 and 8, the apparatus 1 comprises a plurality of receptacles 43 positionable, one at a time, in the stacking station 26 for receiving the foil sheets 100, 101 deposited by the first transfer device 10 and by the second transfer device 101.

Each receptacle 43 comprises a substantially flat stacking surface 44.

When the accompanying device 30 is placed in an intermediate position between the first and second end position P1, P2, the accompanying device 30 is at a higher level than the stacking surface 44.

When the accompanying device 30 is placed in the first end position P1, the accompanying device 30 is at a lower level than the stacking surface 44.

When the accompanying device 30 is placed in the second end position P2, the accompanying device 30 is at a lower level than the stacking surface 44.

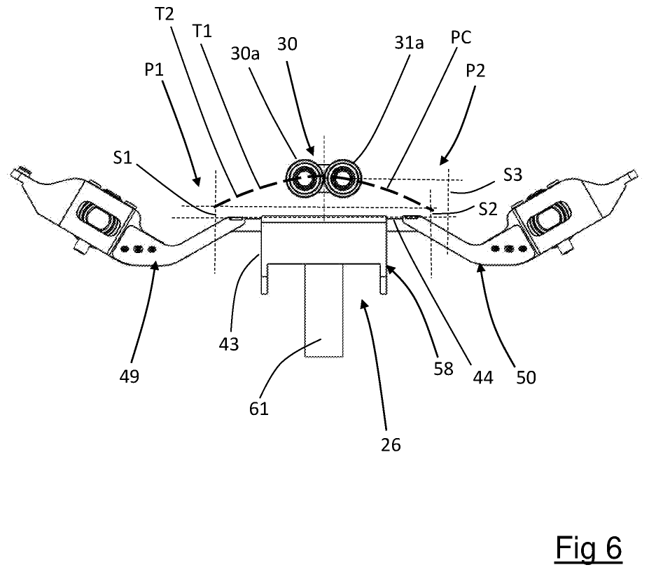

FIG. 6 illustrates in a front view some parts of the apparatus 1 and in particular the first accompanying roller 30a, the second accompanying roller 31a (represented in a central area of the stacking station 26), a receptacle 43 placed in the stacking station 26 and further components that will be described below. The curved path PC followed by the first accompanying roller 30a and the second accompanying roller 31a has been represented in dotted line.

As schematically represented in FIG. 6, the first accompanying roller 30a and the second accompanying roller 31a, when they are in the first end position P1, are placed at a first distance S1 from the stacking surface 44 of the receptacle 43, placed in the stacking station 26.

Said first distance S1 is measured in a direction perpendicular to the stacking surface 44 and between the rotation axis R1 of the first accompanying roller 30a and the stacking surface 44.

In FIG. 6, the first distance S1 is represented, for explanatory purposes, as a positive distance, in the sense that it is a distance measured above the stacking surface 44.

However, the first distance S1 may be understood as a negative distance, i.e. measured below the stacking surface 44.

The first accompanying roller 30a and the second accompanying roller 31a, when they are in the second end position P2, are placed at a second distance S2 from the stacking surface 44 of the receptacle 43, placed in the stacking station 26.

Said second distance S2 is measured in a direction perpendicular to the stacking surface 44 and between the rotation axis R2 of the second accompanying roller 31a and the stacking surface 44.

In FIG. 6, the second distance S2 is represented, for explanatory purposes, as a positive distance, in the sense that it is a distance measured above the stacking surface 44.

However, the second distance S2 is to be understood as a negative distance, i.e. measured below the stacking surface 44.

In an intermediate position between the first P1 and the second end position P2, the first accompanying roller 30a and the second accompanying roller 31a are placed at a third distance S3 from the stacking surface 44.

Said third distance S3 is measured in a direction perpendicular to the stacking surface 44 and between the apex of the curved path PC and the stacking surface 44. This intermediate position is placed in a central position between the first P1 and the second end position P2.

The first distance S1, the second distance S2 and the third distance S3 are directly proportional to the distances of the continuous ribbon-like separator 102 from the stacking surface 44 during its deposition in the stacking station 26.

As schematically represented in FIG. 6, the first distance S1 is substantially equal to the second distance S2 and is smaller than the third distance S3.

To ensure that the first accompanying roller 30a and the second accompanying roller 31a follow the curved path PC, the displacement device 29 comprises an actuator 45 connected to the first accompanying roller 30a and to the second accompanying roller 31a for moving the latter between the first end position P1 and the second end position P2 and between the second end position P2 and the first end position P1.

The actuator 45 comprises an oscillating arm 46 hinged at a first end thereof to an actuating shaft 47 (represented schematically in FIG. 5). The first accompanying roller 30a and the second accompanying roller 31a are hinged to the oscillating arm 46 at a second end thereof.

The oscillating arm 46 comprises a housing seat 48 inside which at least part of the motorized members 34 are placed. In particular, as shown in FIG. 7, the motorized pulley 35 and the first pulley 36, the second pulley 37 and the drive belt 38 are arranged inside the housing seat.

The actuating shaft 47 is placed parallel to the motorized shaft 41 that rotates the motorized pulley 35. In the embodiment illustrated in the accompanying figures, the actuating shaft 47 and the motorized shaft 41 are coaxial.

The actuating shaft 47 is placed, with respect to said stacking station 26, on the opposite side with respect to said feeder device 27 of a continuous ribbon-like separator, so as to be able to direct the concavity of the curved path PC towards the stacking station 26 and towards the stacking surface 44.

The actuating shaft 47 moves the oscillating arm 46 with a reciprocating motion having a first dead centre at the first end position P1 and a second dead centre at the second end position P2.

In other words, to the first accompanying roller 30a and to the second accompanying roller 31a it is imparted a law of motion in accordance, i.e. coordinated, with that of the oscillating arm 46, so that the first accompanying roller 30a and the second accompanying roller 31a roll without sliding on the continuous ribbon-like separator 102.

In the passage between the first end position P1 and the second end position P2, the rotation speed of the actuating shaft 47 causes the first displacement speed V1 of the rotation axis R1 of the first accompanying roller 30a. Similarly, in the passage between the second end position P2 and the first end position P1, the rotation speed of the actuating shaft 47 causes the second displacement speed V2 of the rotation axis R1 of the first accompanying roller 30a.

To retain the continuous ribbon-like separator 102 on the foil sheets 100, 101 deposited in the stacking station 26, the apparatus 1 comprises a first retaining device 49 and a second retaining device 50.

As shown in FIGS. 1 to 4, the first retaining device 49 is arranged at the first end position P1 and the second retaining device 50 is arranged at the second end position P2 of the first accompanying roller 30a and of the second accompanying roller 31a.

The first retaining device 49 and the second retaining device 50 are placed on the opposite side of the receptacle 43 placed in the stacking station 26.

The first retaining device 49 has the function of retaining a portion of continuous ribbon-like separator 102 deposited on the last second foil sheet 101 deposited by the second transfer device 11 in the stacking station 26. This condition is shown in FIG. 1.

The first retaining device 49 continues to retain this portion of continuous ribbon-like separator 102 while the continuous ribbon-like separator 102 is deposited on the next first foil sheet 100 which is deposited by the first transfer device 10 in the stacking station 26. In FIGS. 2 and 3, the first transfer device 10 is schematically shown while it is depositing this next first foil sheet 100 in the stacking station 26 and while the first retaining device 49 is retaining the continuous ribbon-like separator 102.

The second retaining device 50 has the function of retaining a portion of continuous ribbon-like separator 102 deposited on the last first foil sheet 100 deposited by the first transfer device 10 in the stacking station 26. This condition is shown in FIG. 3.

The second retaining device 50 continues to retain this portion of continuous ribbon-like separator 102 while the continuous ribbon-like separator 102 is deposited on the next second foil sheet 101 which is deposited by the second transfer device 11 in the stacking station 26. In FIGS. 4 and 1 the second transfer device 11 is schematically shown while it is depositing this next second sheet 101 in the stacking station 26 and while the second retaining device 50 is retaining the continuous ribbon-like separator 102.

When this next second foil sheet 101 is deposited in the stacking station 26, the first retaining device 49 is brought into a release condition in which it temporarily releases the retained continuous ribbon-like separator portion 102. The first retaining device 49 is subsequently returned to a retaining condition to retain a new portion of continuous ribbon-like separator 102 just deposited on said next second foil sheet 101.

Similarly, when a next first foil sheet 100 is deposited in the stacking station 26, the second retaining device 50 is brought into a release condition in which it temporarily releases the retained continuous ribbon-like separator 102. The second retaining device 50 is subsequently returned to a retaining condition to retain a new portion of continuous ribbon-like separator 102 just deposited on said next first foil sheet 100.

The passage of the first retaining device 49 from the retaining position to the release position and from the release position to the retaining position takes place when the first accompanying roller 30a and the second accompanying roller 31a are in the first end position P1.

The passage of the second retaining device 50 from the retaining position to the release position and from the release position to the retaining position takes place when the first accompanying roller 30a and the second accompanying roller 31a are in the second end position P2.

It should be noted that when the first accompanying roller 30a and the second accompanying roller 31a reach the first end position P1, the movement direction of the first accompanying roller 30a and of the second accompanying roller 31a is reversed to allow the first accompanying roller 30a and the second accompanying roller 31a to move toward the second end position P2. At the time of the reversal of the motion of the first accompanying roller 30a and of the second accompanying roller 31a, the first accompanying roller 30a and the second accompanying roller 31a may be stopped to allow the first retaining device 49 to move from the retaining position to the release position and from the release position to the retaining position.

Similarly, when the first accompanying roller 30a and the second accompanying roller 31a reach the second end position P2, the movement direction of the first accompanying roller 30a and of the second accompanying roller 31a is reversed to allow the first accompanying roller 30a and the second accompanying roller 31a to move toward the first end position P1. At the time of the reversal of the motion of the first accompanying roller 30a and of the second accompanying roller 31a, the first accompanying roller 30a and the second accompanying roller 31a may be stopped to allow the second retaining device 50 to move from the retaining position to the release position and from the release position to the retaining position.

To switch the first retaining device 49 from the retaining position to the release position and from the release position to the retaining position, the first retaining device 49 performs a movement having a displacement component perpendicular to the stacking surface 44 of the receptacle 43.

This displacement component has an extension greater than the first distance S1 of the first accompanying roller 30a and of the second accompanying roller 31a from the stacking surface 44 of the receptacle 43 (when the first accompanying roller 30a and the second accompanying roller 31a are in the first end position P1).

This displacement component has a smaller extension than the third distance S3 of the first accompanying roller 30a and of the second accompanying roller 31a from the stacking surface 44 of the receptacle 43 (when the first accompanying roller 30a and the second accompanying roller 31a are in the intermediate position between the first end position P1 and the second end portion P2).

Similarly, to switch the second retaining device 50 from the retaining position to the release position and from the release position to the retaining position, the second retaining device 50 performs a movement having a displacement component perpendicular to the stacking surface 44 of the receptacle 43.

This displacement component has an extension greater than the second distance S2 of the first accompanying roller 30a and of the second accompanying roller 31a from the stacking surface 44 of the receptacle 43 (when the first accompanying roller 30a and the second accompanying roller 31a are in the second end position P2).

This displacement component has a smaller extension than the third distance S3 of the first accompanying roller 30a and of the second accompanying roller 31a from the stacking surface 44 of the receptacle 43 (when the first accompanying roller 30a and the second accompanying roller 31a are in the intermediate position between the first end position P1 and the second end portion P2).

As better illustrated in FIG. 8, the first retaining device 49 and the second retaining device 50 are structurally identical to each other and are specular with respect to a plane perpendicular to the stacking surface 44 and containing the actuating shaft 47.

Both the first retaining device 49 and the second retaining device 50 comprise a pair of retaining fingers 51 in which one retaining finger faces the other retaining finger along a direction parallel to the rotation axis R1, R2 of the first accompanying roller 30a and of the second accompanying roller 31a. Both the first retaining device 49 and the second retaining device 50 are driven by an electric motor 52. The electric motor 52 is configured to raise and lower the pair of retaining fingers 51 along a direction perpendicular to the stacking surface 44. A further electric motor 53 is also connected to a return linkage 54 that moves the fingers of the pair of retaining fingers 51 away from each other along a direction parallel to the rotation axis R1, R2 of the first accompanying roller 30a and of the second accompanying roller 31a.

When the first retaining device 49 and the second retaining device 50 move from the retaining position to the release position, the fingers of the pair of retaining fingers 51 are moved away from each other losing contact with the continuous ribbon-like separator 102 and are subsequently raised until overcoming the aforementioned respective first and second distances S1, S2. When the first retaining device 49 and the second retaining device 50 move from the release position to the retaining position, the fingers of the pair of retaining fingers 51 are moved closer to each other by positioning themselves above the continuous ribbon-like separator 102 and are subsequently lowered by retaining the continuous ribbon-like separator 102.

As mentioned above, there is provided a plurality of receptacles 43.

Each receptacle 43 is movable between the stacking station 26 and an unloading station 55.

In the embodiment illustrated in the accompanying figures, there are provided three receptacles 43, as best represented in FIGS. 7 and 8.

When more than two receptacles 43 are provided, transit stations 56 are provided in a number equal to the number of receptacles 43 decreased by two. In the illustrated example, where there are three receptacles 43, there is provided a transit station 56.

In these cases, each receptacle 43 is movable between the stacking station 26, the unloading station 55 and the transit station 56.

The stacking station 26, the unloading station 55 and the transit station 56 follow each other cyclically along a transport path of the receptacles 43 in predetermined order.

Such a predetermined order may provide that the stacking station 26 is followed by the unloading station 55 or that the stacking station 26 is followed by one or more transit stations 56.

The stacking station 26, the unloading station 55 and the transit station 56 (when present) are equally spaced along a transport path.

In the preferred embodiment of the invention, the stacking station 26 is followed by the unloading station 55 which is followed by the transit stations 56.

In the unloading station 55, the electrochemical cell formed in the stacking station 26 is removed from the receptacle 43. In the preferred embodiment of the invention, the receptacles 43 transiting in the transit stations 56 are empty, i.e. they do not contain foil sheets.

When a receptacle 43 is in the stacking station 26 another receptacle 43 is always in the unloading station 55.

All receptacles 43 move simultaneously between the stacking station 26, the unloading station 55 and, if present, the transit stations 56. When the receptacles 43 move between the stacking station 26, the unloading station 55 and, if present, the transit stations 56, the deposition of the foil sheets 100, 101 is interrupted.

The transport path of the receptacles 43 follows a trajectory that begins and ends at the stacking station 26.

This trajectory is a trajectory closed on itself.

This trajectory is a circular trajectory.

In the preferred embodiment of the invention (FIGS. 7 and 8), the receptacles 43 are mounted on the periphery of a transport drum 57 in such a way as to be able to follow the aforementioned closed trajectory.

The transport drum 57 is rotatable about a transport axis TR1 (illustrated in FIG. 8) parallel to the rotation axes R1, R2 of the first accompanying roller 30a and of the second accompanying roller 31a.

The transport drum 57 is mounted on the frame 9 in such a way that the transport axis TR1 is below the stacking station 26, i.e. it is on the opposite side of the feeder device 27 with respect to the stacking station 26.

The transport axis TR1 is parallel and coincident with an axis of the actuating shaft 47 that moves the oscillating arm 46.

The transport drum 57 is rotatable about the transport axis TR1 making angular rotations interspersed with stops. These angular rotations are of such an extent necessary to bring a receptacle 43 from a station to the next station and the stops are of a duration equal to the time of formation of an electrochemical cell in the stacking station 26.

The stacking station 26, the unloading station 55 and the transit station 56 (when present) are placed along the periphery of the transport drum 57 and are fixed with respect to the frame 9.

To allow that during the rotation of the transport drum 57 the electrochemical cell formed in the stacking station 26 does not move with respect to the receptacle 43 in which it was formed and from which it must be removed, there is provided an anchoring device 58 active on each receptacle 43.

Each anchoring device 58 is switchable between a retaining position in which it retains the foil sheets 100, 101 stacked on a receptacle 43 and a release position in which it does not retain the foil sheets 100, 101 stacked on the receptacle 43.

The anchoring device 58 active on a receptacle 43 is in the retaining position when said receptacle 43 moves between the stacking station 26 and the unloading station 55.

The anchoring device 58 active on a receptacle 43 placed in the stacking station 26 is in the release position at least until the first transfer device 10 and the second transfer device 11 are depositing the first foil sheets 100 and the second foil sheets 101 in the receptacle 43.

The anchoring device 58 active on a receptacle 43 is in the release position when said receptacle moves between the unloading station 55 and the stacking station 26 (possibly transiting in the transit stations 56).

The anchoring device 58 of a receptacle 43 placed in the stacking station 26 is active on two opposite ends of the stacking surface 44, and the first retaining device 49 and the second retaining device 50 are active on said receptacle 43 on the further two opposite ends of the stacking surface 44.

Each anchoring device 58 comprises a pair of anchoring fins 59 (FIG. 8) hinged to the transport drum 57 along hinge axes contained in planes perpendicular to the transport axis TR1.

Each anchoring fin of the pair of anchoring fins 59 is placed at ends of the stacking surface 44, wherein said opposite ends of the stacking surface 44 are spaced apart along a direction parallel to the rotation axes R1, R2 of the first accompanying roller 30a and of the second accompanying roller 31a.

Each anchoring fin 59 comprises a lip 60 which, when the fins are in the anchoring position, is arranged parallel to the stacking surface 44 of the receptacle 43. When the fins are in the release position, the lip 60 is out of the way of the stacking surface 44 of the receptacle 43.

In order to allow to the anchoring fins 59 to properly retain the foil sheets 100, 101 deposited on the stacking surface 44 regardless of the number of foil sheets overlapping on each other, the stacking surface 44 of each receptacle is movable between a plurality of stacking positions.

As shown schematically in FIG. 5, the stacking surface 44 is connected to the receptacle 43 through one or more supports 61 slidable in the receptacle 43 along a direction perpendicular to the stacking surface 44. These supports 66 may have different degrees of insertion into the receptacle 43 in which each degree of insertion corresponds to a respective stacking position of the stacking surface 44.

In the preferred embodiment of the invention, a stacking position is spaced from an adjacent (or next) stacking position by a distance substantially corresponding to the thickness of a foil sheet 100, 101 and to the thickness of the ribbon-like support 102.

The stacking surface 44 may for example be retained by the first retaining device 49 or by the second retaining device 50 in a reached stacking position.

It should be noted that the stacking positions of the stacking surface 44 further allows to ensure that each foil sheet 100, 101 placed on the stacking surface 44 is always at the same distance from the actuating shaft 47 of the oscillating arm 46.

In use, for alternately stacking the continuous ribbon-like separator 102 and the foil sheets 100, 101, the first foil sheets 100 and the second foil sheets 101 are transferred to the stacking station 26 in an alternating manner, i.e. one at a time and with a succession providing for an alternation between the first foil sheets 100 and the second foil sheets 101.

The continuous ribbon-like separator 102 is fed to the stacking station 26. The continuous ribbon-like separator 102 is engaged by the accompanying device 30.

Starting from a situation in which a second foil sheet 101 has just been deposited, the continuous ribbon-like separator 102 is engaged by the accompanying surface 31 to move the continuous ribbon-like separator 102 above the stacking station 26 between the first end position P1 and the second end position P2.

This action is carried out by moving the rotation axis R1 of the first accompanying roller 30a of the accompanying device 30 between the first end position P1 and the second end position P2.

The accompanying surface 31 is set in motion, and in particular in rotation in accordance with the preferred embodiment of the invention, imposing a first predetermined relative speed between the accompanying surface 31 and the continuous ribbon-like separator 102.

This first relative speed is given by the difference between a first accompanying speed of the accompanying surface 31 and a first displacement speed of the continuous ribbon-like separator 102 between the first end position P1 and the second end position P2.

To cancel or in any case decrease relative slippages between the accompanying surface 31 and the continuous ribbon-like separator 102, the magnitude of the first accompanying speed is comprised between 80% and 120% of the magnitude of the first displacement speed, preferably comprised between 90% and 110% of the magnitude of the first displacement speed, more preferably comprised between 95% and 105% of the magnitude of the first displacement speed.

This action is carried out by providing the first accompanying roller 30a of the accompanying device 30 with the outer surface 33 defining the accompanying surface 31 and by rotating the first accompanying roller 30a around the rotation axis R1 at the first angular speed VA1.

The continuous ribbon-like separator 102 is then placed on the second foil sheet 101 transferred to the stacking station 26 following a first curved trajectory T1S between the first end position P1 and the second end position P2.

As a result of this first curved trajectory T1S, during the displacement of the continuous ribbon-like separator 102 between the first end position P1 and an intermediate position between the first end position P1 and the second end position P2, the continuous ribbon-like separator 102 moves perpendicularly to, and away from, the second foil sheet 101 transferred to the stacking station 26.

When the continuous ribbon-like separator 102 reaches the second end position P2, the continuous ribbon-like separator 102 is positioned below a level at which there is the second foil sheet 101 transferred to the stacking station 26.

The second foil sheet 101 transferred to the stacking station is then partially wrapped by the continuous ribbon-like separator 102.

Subsequently, the second retaining device 50 retains a portion of continuous ribbon-like separator 102 deposited on the second foil sheet 101.

Subsequently or simultaneously, a first foil sheet 100 is deposited in the stacking station 26. Said first sheet is deposited above a portion of continuous ribbon-like separator 102 just placed on the second foil sheet 101.

Subsequently, the accompanying device 30 reverses its motion to move between the second end position P2 and the first end position P1.

The continuous ribbon-like separator 102 is engaged by the further accompanying surface 32 to move the continuous ribbon-like separator 102 above the stacking station 26 between the second end position P2 and the first end position P1.

This action is carried out by moving the rotation axis R2 of the second accompanying roller 31a of the accompanying device 30 between the second end position P2 and the first end position P1.

The further accompanying surface 32 is set in motion, and in particular in rotation in accordance with the preferred embodiment of the invention, imposing a second predetermined relative speed between the further accompanying surface 32 and the continuous ribbon-like separator 102.

This second relative speed is given by the difference between a second accompanying speed of the accompanying surface 32 and a second displacement speed of the continuous ribbon-like separator 102 between the second end position P2 and the first end position P1.

To cancel or in any case decrease relative slippages between the further accompanying surface 32 and the continuous ribbon-like separator 102, the magnitude of the second accompanying speed is comprised between 80% and 120% of the magnitude of the second displacement speed, preferably comprised between 90% and 110% of the magnitude of the second displacement speed, more preferably comprised between 95% and 105% of the magnitude of the second displacement speed.

This action is carried out by providing the second accompanying roller 31a of the accompanying device 30 with the outer surface 33a defining the further accompanying surface 32 and by rotating the second accompanying roller 31a around the rotation axis R2 at the second angular speed VA2.

The continuous ribbon-like separator 102 is then placed on the first foil sheet 100 transferred to the stacking station 26 following a second curved trajectory T2S between the second end position P2 and the first end position P1.

As a result of this second curved trajectory T2S, during the displacement of the continuous ribbon-like separator 102 between the second end position P2 and an intermediate position between the second end position P2 and the first end position P1, the continuous ribbon-like separator 102 moves perpendicularly to, and away from, the first foil sheet 100 transferred to the stacking station 26.

When the continuous ribbon-like separator 102 reaches the first end position P1, the continuous ribbon-like separator 102 is positioned below a level at which there is the first soil sheet 101 transferred to the stacking station 26.

The first soil sheet 100 transferred to the stacking station 26 is then partially wrapped by the continuous ribbon-like separator 102.

Subsequently, the first retaining device 49 retains a portion of continuous ribbon-like separator 102 deposited on the first foil sheet 100.

The described process is repeated with the deposition of a further second foil sheet 101.

1. A stacking apparatus for alternately stacking a continuous ribbon-like separator and foil sheets, comprising:
a stacking station configured to receive foil sheets;
a first transfer device for transferring first foil sheets and a second transfer device for transferring second foil sheets respectively movable between a pick-up position and a release position, wherein the release position of the first transfer device and the release position of the second transfer device are placed at said stacking station and wherein when the first transfer device is in the release position the second transfer device is moved away from the release position and wherein when the second transfer device is in the release position the first transfer device is moved away from the release position;
a feeder device of a continuous ribbon-like separator configured to feed a continuous ribbon-like separator towards the stacking station;
a displacement device configured to operate on the continuous ribbon-like separator fed by the feeder device and comprising an accompanying device movable between a first end position and a second end position and above the stacking station when the second transfer device moves from the release position to the pick-up position, and movable from the second end position to the first end position and above the stacking station when the first transfer device moves from the release position to the pick-up position;
wherein the displacement device moves the accompanying device between the first end position and the second end position and between the second end position and the first end position along a curved path.

2. The stacking apparatus according to claim 1, wherein said curved path has concavity facing the stacking station.

3. The stacking apparatus according to claim 1, wherein said displacement device comprises an oscillating arm driven by an actuating shaft and supporting said accompanying device; said actuating shaft being placed, with respect to said stacking station, on an opposite side with respect to said feeder device of a ribbon-like separator.

4. The stacking apparatus according to claim 1, comprising a receptacle configured to receive first and second foil sheets, placed in said stacking station and comprising a substantially flat stacking surface.

5. The stacking apparatus according to claim 4, wherein when said accompanying device is placed in an intermediate position between the first and second end positions, the accompanying device is located, with respect to a direction perpendicular to the stacking surface, on an opposite side of the stacking surface with respect to when said accompanying device is placed in the intermediate position between the first and second end positions.

6. The stacking apparatus according to claim 4, wherein when said accompanying device is placed in the first end position, alternatively or in combination when said accompanying device is placed in the second end position, said stacking surface is interposed, with respect to a direction perpendicular to the stacking surface, between the feeder device and said accompanying device.

7. The stacking apparatus according to claim 4, wherein in the first end position said accompanying device is placed at a first distance from the stacking surface, in the second end position said accompanying device is placed at a second distance from the stacking surface, and in an intermediate position between the first and the second end position said accompanying device is placed at a third distance from the stacking surface; said third distance being greater than the first distance and greater than the second distance.

8. The stacking apparatus according to claim 1, comprising a first retaining device configured to operate on the continuous ribbon-like separator and arranged at the first end position of the accompanying device, and a second retaining device configured to operate on the continuous ribbon-like separator and arranged at the second end position of the accompanying device.

9. The stacking apparatus according to claim 8, wherein said first retaining device is movable between a retaining condition in which it intercepts and retains a portion of the continuous ribbon-like separator and a release condition in which it is moved away from the continuous ribbon-like separator, said first retaining device moving from the retaining condition to the release condition and from the release condition to the retaining condition when the accompanying device is in the first end position.

10. The stacking apparatus according to claim 9, wherein the first retaining device is in the retaining condition when the accompanying device moves from the first end position to the second end position, when the accompanying device is in the second end position and when the accompanying device moves from the second end position to the first end position.

11. The stacking apparatus according to claim 8, wherein said second retaining device is movable between a retaining condition in which it intercepts and retains a portion of the continuous ribbon-like separator and a release condition in which it is moved away from the continuous ribbon-like separator, said second retaining device moving from the retaining condition to the release condition and from the release condition to the retaining condition when the accompanying device is in the second end position.

12. The stacking apparatus according to claim 11, wherein the second retaining device is in the retaining condition when the accompanying device moves from the second end position to the first end position, when the accompanying device is in the first end position and when the accompanying device moves from the first end position to the second end position.

13. The stacking apparatus according to claim 4, wherein said stacking surface is movable between a plurality of stacking positions, wherein at each stacking position the stacking surface is arranged parallel to a respective reference plane, wherein all the reference planes are parallel to each other, and wherein a reference plane is spaced from an adjacent reference plane by a distance greater than or substantially equal to a thickness of a foil sheet.

14. A method for stacking a continuous ribbon-like separator and foil sheets comprising:
transferring first foil sheets and second foil sheets to a stacking station;
feeding a continuous ribbon-like separator to the stacking station;
laying the continuous ribbon-like separator on the first foil sheets and the second foil sheets transferred to the stacking station, wherein laying the continuous ribbon-like separator comprises moving the continuous ribbon-like separator above the stacking station along a first trajectory between a first end position and a second end position and along a second trajectory between the second end position and the first end position, where the first trajectory and the second trajectory are curved trajectories.

15. The method according to claim 14, wherein moving the continuous ribbon-like separator above the stacking station comprises, during a displacement of the continuous ribbon-like separator from the first end position to an intermediate position between the first end position and the second end position, moving the continuous ribbon-like separator perpendicularly to, and away from, one of the second foil sheets transferred to the stacking station.

16. The method according to claim 14, wherein moving the continuous ribbon-like separator above the stacking station comprises, during a displacement of the continuous ribbon-like separator from an intermediate position between the first end position and the second end position, moving the continuous ribbon-like separator perpendicularly to, and towards, one of the second foil sheets transferred to the stacking station.

17. The method according to claim 14, wherein moving the continuous ribbon-like separator above the stacking station comprises moving the continuous ribbon-like separator to the first end position and below a level at which there is one of the first foil sheets transferred to the stacking station.

18. The method according to claim 14, wherein moving the continuous ribbon-like separator above the stacking station comprises moving the continuous ribbon-like separator to the second end position and below a level at which there is one of the second foil sheets transferred to the stacking station.

19. The method according to claim 14, wherein the first trajectory of the continuous ribbon-like separator coincides with the second trajectory of the continuous ribbon-like separator.

20. Method according to any one of claims 14 to 19, wherein the first trajectory and the second trajectory of the continuous ribbon-like separator have concavity facing the stacking station.

21. The method according to 14, wherein moving the continuous ribbon-like separator above the stacking station along the first trajectory between a first end position and a second end position and along the a second trajectory between a second end position and a first end position comprises partially wrapping the first foil sheets and the second foil sheets transferred to the stacking station with the continuous ribbon-like separator.

22. The method according to claim 14, wherein transferring first foil sheets and second foil sheets to a stacking station comprises depositing first foil sheets alternating and overlapping with second foil sheets on a stacking surface.

23. The stacking apparatus according to claim 1, wherein when said accompanying device is placed in the first end position, the accompanying device is at a lower level than the stacking surface.
